(19) United States
(12) Patent Application Publication
(10) Pub. No.: US 2005/0081719 A1
(43) Pub. Date: Apr. 21, 2005

(54) Air filtering system

(76) Inventor: Thomas Carlsson, Boras (SE)

Correspondence Address: HARNESS, DICKEY & PIERCE, P.L.C., P.O. BOX 8910, RESTON, VA, 20195, US

(21) Appl. No.: 10/952,907

(22) Filed: Sep. 30, 2004

(30) Foreign Application Priority Data
Oct. 21, 2003 (SE) 0302777-8

(51) Int. Cl. B03C 3/00

(52) U.S. Cl. 96/223

(57) ABSTRACT

A system in filtration of air comprises a filter (4) for separation of particles and a means (3) for ionization of the air. In use of the system, ionization of the air occurs before the air passes said filter (4). The filter (4) is made up of fibers of polypropylene mixed with acrylic.

### FIELD OF THE INVENTION

The present invention relates to a system in filtration of air, comprising a filter for separation of particles and a means for ionization of the air, ionization of the air, in use of the system, occurring before the air passes said filter.

### BACKGROUND ART

Systems as described above are today of frequent occurrence. Ionization means that the degree of separation is increased, or alternatively that penetration decreases. In filters, it is desirable to have as little penetration of particles as possible and at the same time have as small a pressure drop as possible. A filter system with a relatively coarse filter which usually has a penetration of about 35% can be improved by ionization of the air before the air passes through the filter. The penetration can for the same filter as described above be reduced to about 10% by ionization of the air before the air passes through the filter. Thus, such a system has the advantage that the pressure drop is low as a consequence of a coarse filter being used while at the same time penetration decreases. In some cases, however, it is necessary for the penetration of particles to be still lower. This is achieved in prior-art technique by using filters with finer fibers, i.e. tighter filters, which however also bring about the effect that the pressure drop increases. Getting penetration down from 10% means as a rule that the pressure drop increases since a “tighter” filter has to be used.

### SUMMARY OF THE INVENTION

The object of the present invention therefore is to provide a system in filtration of air, which system reduces the penetration of particles still more compared with prior-art technique, while at the same time the pressure drop is maintained.

According to the invention, this object is achieved by the system of the type stated by way of introduction being given the features that are evident from claim 1. Preferred embodiments of the system are defined in the appended claims.

The inventive system in filtration of air comprises a filter for separation of particles and a means for ionization of the air, ionization of the air, in use of the system, occurring before the air passes said filter. Moreover, the filter is made up of fibers of polypropylene mixed with acrylic.

Thus, the invention is based on the fact that it has been found that precisely the combination of ionizing the air and, after that, filtering the air using a filter made up of fibers of polypropylene mixed with acrylic results in a penetration of particles that is as low as 1 to 2%. This should be compared with the previously mentioned penetration of about 10%. The main advantage thus is that the pressure drop is the same in spite of an essentially decreased penetration.

A particularly low penetration of particles is obtained if modified acrylic is used. In this case modified acrylic means that polyvinyl chloride is grafted into the acrylic.

In one embodiment, the system is arranged in an air cleaner. The air cleaner can in some cases be a solution when it is desirable to reduce the particle content of indoor air, especially in rooms without mechanical supply of air. Under certain conditions, however, large amounts of particles are generated in a room owing to the activities performed, and then it is suitable to have also a separate air cleaner in addition to cleaning of the supply air.

In an alternative embodiment, the system is arranged in an air supply system. The advantage of this is that the supplied air is filtered and, thus, no extra space-requiring “can” is necessary in the room in order to clean the air. However, particles generated in the room will consequently not be filtered off.

In another alternative embodiment of the present invention, a means is arranged downstream of the filter in the system for bipolar ionization of the air. Due to this ionization, small particles in the air react with each other and precipitate on the floor. The energy level of the oxygen in the air is increased and accelerates the breaking-down of organic substances in the air. In this way odors and harmful substances are effectively broken down.

### BRIEF DESCRIPTION OF FIGURES

The invention will below be described in more detail by means of embodiments with reference to the accompanying schematic figures which by way of example illustrate currently preferred embodiments of the invention.

FIG. 1 is a schematic view of a system according to the present invention arranged in an air cleaner.

FIG. 2 is a schematic view of a system according to the present invention arranged in an air supply system.

FIG. 3 illustrates a system according to FIG. 1 with a means for bipolar ionization.

FIG. 4 illustrates a system according to FIG. 2 with a means for bipolar ionization.

### DESCRIPTION OF PREFERRED EMBODIMENTS

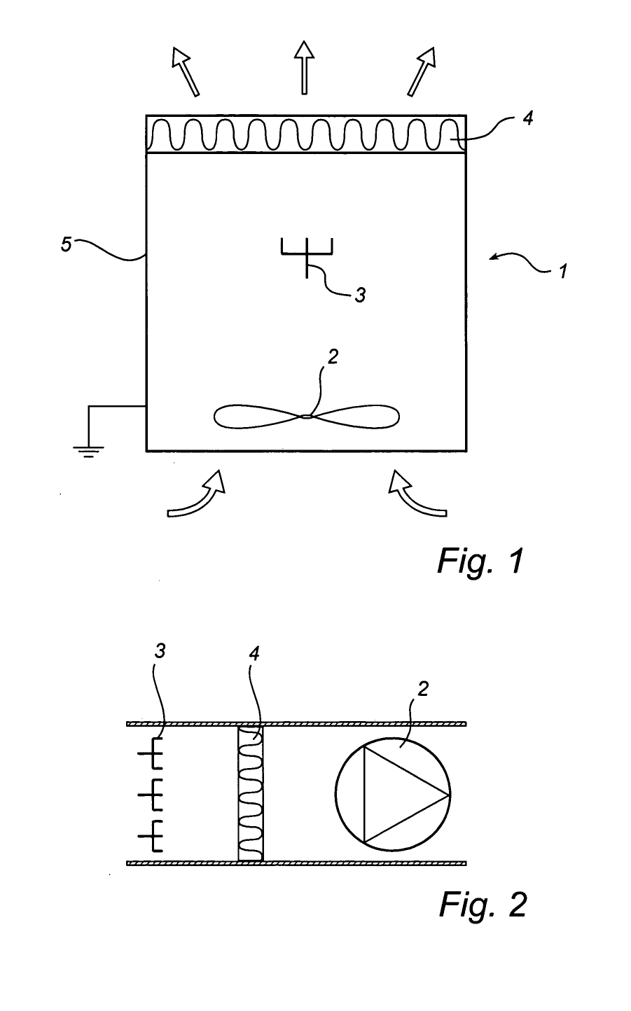

FIG. 1 shows an air cleaner 1 comprising a fan 2, an ionizing means 3, a filter 4 and an earthed casing 5. The air is delivered to the air cleaner 1 by means of the fan 2, after which the air flows past the ionizing means 3, whereby the air is ionized. After the air has been ionized, it thus flows through the filter 4. The filter 4 is preferably made of polypropylene mixed with modified acrylic, i.e. in this case polyvinyl chloride is grafted into the acrylic. The polypropylene fibers and the acrylic are processed in a carding process to produce filter material comprising portions which are negatively charged and other portions which are positively charged, an electric field arising in the filter material that helps to catch the particles in the ionized air. The effect of the ionization differs, depending on the properties of the particles, such as material, size and temperature. In some cases, the particles form lumps, which makes it easier for them to be absorbed by the filter 4. In other cases, it is the increased attraction of the particles that makes them more easily affected by the electric field in the filter 4. In some cases, a combination of these two effects may of course be used.

In FIG. 2, an ionizing means 3 and a filter 4 are arranged in an air supply duct where the air is filtered before it reaches the fan 2, which is the normal procedure in air supply devices. The principle of filtering is the same as for the air cleaner in FIG. 1, except that it is only the supply air that is being filtered. Particles generated in the ventilated space are thus not filtered.

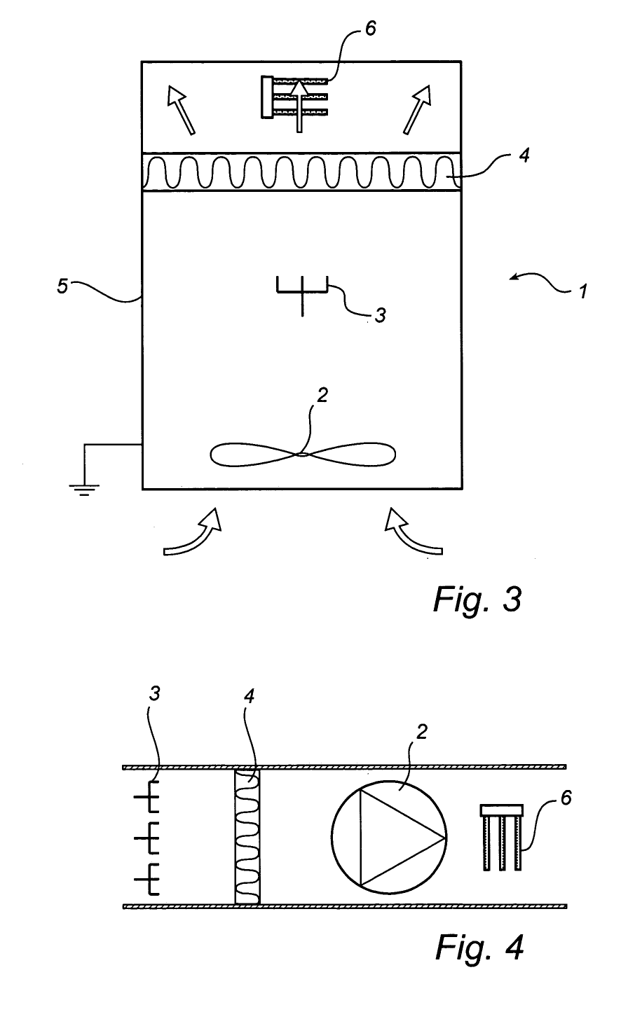

In order to further improve the quality of air, it is possible to arrange an ionizing means 6 after the filter 4 so as to ionize the air and the particles passing through the filter 4 in a bipolar manner. The particles will then form lumps and precipitate on the floor. Also the energy level of the oxygen in the air is increased, which accelerates the breaking-down of organic substances in the air. FIGS. 3 and 4 illustrate a corresponding air cleaner 1 from FIG. 1 and a system according to the present invention in an air supply duct from FIG. 2, where a means 6 is arranged for bipolar ionization of the air after passing through the filter 4.

It will be appreciated that many modifications of the embodiments described above are conceivable within the scope of the invention, as defined by the appended claims.

1. A system in filtration of air, comprising a filter for separation of particles and a means for ionization of the air, ionization of the air, in use of the system, occurring before the air passes said filter,
wherein
the filter is made up of fibers of polypropylene mixed with acrylic.

2. A system as claimed in claim 1, in which polyvinyl chloride is grafted into the acrylic.

3. A system as claimed in claim 1, which system is arranged in an air cleaner.

4. A system as claimed in claim 1, which system is arranged in an air supply system.

5. A system as claimed in claim 1, in which a means is arranged to ionize the air in a bipolar manner after the air, in use of the system, has passed said filter.
